(19) United States
(12) Patent Application Publication
(10) Pub. No.: US 2024/0247360 A1
(43) Pub. Date: Jul. 25, 2024

(54) WEAR-RESISTANT CHROMIUM-FREE IRON-BASED HARDFACING

(71) Applicant: OERLIKON METCO (US) INC., Westbury, NY (US)

(72) Inventors: Jonathon BRACCI, Escondido, CA (US); Justin CHENEY, Encinitas, CA (US)

(73) Assignee: OERLIKON METCO (US) INC., Westbury, NY (US)

(21) Appl. No.: 18/286,846

(22) PCT Filed: Apr. 14, 2022
(86) PCT No.: PCT/US22/24860

§ 371 Date: Oct. 13, 2023

Related U.S. Application Data
(60) Provisional application No. 63/175,795, filed on Apr. 16, 2021.

(51) Int. Cl. C23C 4/08; C22C 38/00; C22C 38/06; C22C 38/12; C23C 4/134

(52) U.S. Cl. CPC C23C 4/08; C22C 38/002; C22C 38/06; C22C 38/12; C23C 4/134

(57) ABSTRACT

A thermal spray material feedstock is provided that includes an iron-based alloy having 5-12 wt % of Al; 1.8-7.5 wt % of B; 0-2 wt % of C; 0-4.5 wt % of Mo; 0-6.5 wt % of V; and a balance of Fe. The iron-based alloy is substantially free of chromium and nickel.

### CROSS-REFERENCE TO RELATED APPLICATION

This application claims the benefit and priority of U.S. Provisional Application No. 63/175,795 filed Apr. 16, 2021, the disclosure of which is expressly incorporated by reference herein in its entirety.

### BACKGROUND OF THE INVENTION

### 1. Field of the Disclosure

The present disclosure relates to a thermal spray material feedstock having an iron-based alloy that is substantially free of chromium and nickel. The thermal spray material feedstock is effective for thermally spraying, laser cladding, or weld overlay hardfacing processes.

### 2. Background Information

Conventional hardfacing alloys contain chromium. Chromium improves abrasion resistance, corrosion resistance, and wear resistance by formation of hard phases, such as carbides, borides, or borocarbides. Almost all conventional stainless steel and nickel-based superalloys utilize chromium to impart a desired level of corrosion resistance to the alloy. However, when alloys containing chromium are subjected to a welding or thermal spraying process, a dangerous amount of chromium in the alloy can be released into the air as hexavalent chromium. Hexavalent chromium is a known carcinogen and toxic to the human body. If inhaled, hexavalent chromium can result in lung damage, nasal damage, throat damage, or cancer. Therefore, it is important to develop chromium free materials to mitigate this health concern.

A drawback to removing chromium from an alloy system is the loss of corrosion resistance. This is especially true for iron-based alloys. In certain applications, corrosion resistance is unnecessary, and chromium-free alloys can be utilized. However, in most applications it is a requirement that the alloy does not rust or corrode.

Several chromium-free weld and thermal spray hardfacing alloys have been developed. One example is Patent Document 1 that teaches a chromium-free alloy consisting of bainitic steel with 60%-75% iron boride.

A second example is the disclosure in each of Patent Document 2, Patent Document 3, and Patent Document 4. All three disclosures teach chromium-free alloys that contain nickel. Like chromium, nickel and nickel-containing alloys have also been under scrutiny by environmental and health organizations in recent years. It is therefore important to avoid nickel and chromium in the alloy.

A third example is Patent Document 5 that teaches a chromium-free alloy containing titanium. The addition of titanium can cause manufacturability challenges, particularly if the alloy will be subjected to an inert gas atomization process. Therefore, it is desirable to avoid titanium in the alloy.

A fourth example is Patent Document 6 that teaches a chromium-free, wear-resistant alloy. This disclosure includes an example having an alloy forming tungsten and molybdenum borides and MC carbides, which can be composed of vanadium, titanium, niobium, zirconium, hafnium, tungsten, or molybdenum. In embodiments, the iron-based alloy of the present disclosure is free of tungsten and any type of carbide. Again, this is to reduce cost and improve manufacturability. In embodiments, the iron-based alloy of the present disclosure has a high boride content of 40 wt % or more and/or a low carbon content.

In embodiments, the iron-based alloy of the present disclosure has a boride content of 30 wt % to 65 wt %. In other embodiments, the iron-based alloy of the present disclosure has a boride content of 35 wt % to 65 wt %. In yet other embodiments, the iron-based alloy of the present disclosure has a boride content of 40 wt % to 65 wt %.

In embodiments, the iron-based alloy of the present disclosure has a carbon content that is less than 2.0 wt %. In other embodiments, the iron-based alloy of the present disclosure has a carbon content of less than 1.5 w %. In yet other embodiments, the iron-based alloy of the present disclosure has a carbon content of less than 1.0 wt %.

A fifth example is Patent Document 7 that teaches a chromium-free iron-based thermal spray material containing up to 4.5 wt % aluminum. To provide adequate corrosion resistance, the present disclosure contains more than 5.0 wt % aluminum. In the present disclosure, aluminum is the primary element that contributes to the corrosion resistance of the chromium-free iron-based alloy. Therefore, it is important in the present disclosure to maximize the aluminum content.

However, none of the alloys described in Patent Literatures 1-7 provide corrosion resistance and/or improved hardness of the alloy or coating. The present disclosure provides alloys that are substantially chromium-free, substantially nickel-free, and wear-resistant.

### BACKGROUND ART DOCUMENTS

### Patent Document 1

U.S. Pat. No. 8,268,543

### Patent Document 2

US Pub. No. 2013/0294962

### Patent Document 3

US Pub. No. 2005/010126

### Patent Document 4

U.S. Pat. No. 7,569,286.

### Patent Document 5

US Pub. No. 2010/000858

### Patent Document 6

U.S. Pat. No. 10,105,796

### Patent Document 7

US Pub. No. 2020/198302

### SUMMARY

An object of the present disclosure is to provide an iron-based alloy that is substantially chromium-free and nickel-free while still maintaining wear resistance for welding and thermal spraying applications, a thermal spray material feedstock that includes the iron-based alloy, a hardfacing material that includes the iron-based alloy, and methods for manufacturing the hardfacing material. Methods for manufacturing can include cored wire filling, forming, and drawing and powder atomization.

“Substantially chromium-free” is defined as less than 1.0 wt %. Preferably “Substantially chromium-free” is defined as less than 0.5 wt %. More preferably “Substantially chromium-free” is defined as less than 0.1 wt %.

Example embodiments of the present disclosure relate to hardfacing/hardbanding materials, alloys or powder compositions used to manufacture the hardfacing/hardbanding materials, methods for manufacturing the hardfacing/hardbanding materials, components or substrates that incorporate these hardfacing/hardbanding materials, and components or substrates that are protected by these hardfacing/hardbanding materials. Examples of these components or substrates can be, but are not limited to, pulp and paper applications. Pulp and paper applications include the following components and coatings for the following components: Rolls used in paper machines including yankee dryers, through air dryers, and other dryers, calendar rolls, machine rolls, press rolls, winding rolls, digesters, pulp mixers, pulpers, pumps, boilers, shredders, tissue machines, roll and bale handling machines, fiber guidance systems such as deflector blades, doctor blades, evaporators, pulp mills, head boxes, wire parts, press parts, M.G. cylinders, pope reels, winders, vacuum pumps, deflakers, and other pulp and paper equipment.

In many applications, components thermally sprayed or hardfaced with a coating are exposed to corrosive environments. In several of these applications, chromium is added to the coating to provide adequate corrosion resistance. However, due to environmental, health, and safety concerns over hexavalent chromium, an object of the present disclosure is to avoid or minimize the amount of chromium in the coating material feedstock.

Examples of the present disclosure utilize aluminum in place of chromium to provide corrosion resistance to the coating. It is well known that aluminum produces an aluminum oxide layer when exposed to oxygen. This aluminum oxide layer helps protect the underlying coating from further corrosive attack. Example embodiments of the present disclosure relate to alloys with 5.0 wt % or more of aluminum.

In addition, many applications require the coating to be wear-resistant. Accordingly, in example embodiments, the hardfacing coating forms iron boride. Iron boride is a hard, wear-resistant phase, that generally forms as Fe₂B. The addition of molybdenum and vanadium also promote the formation of Mo₃B₂ and V₃B₄ boride phases that improve wear-resistance to the coating. In embodiments of the present disclosure, the hardfacing coating contains less than 60% iron boride.

In example embodiments, computational metallurgy is used to identify alloys that form Fe₂B, Mo₃B₂, and V₃B₄ boride that ranges between 15.5-65.5 mol % in an Fe—Al Body-Centered Cubic (BCC) matrix phase. The matrix contains a maximum amount of aluminum to provide adequate corrosion resistance for the coating. In example embodiments, the aluminum content in the iron BCC matrix phase is 5.5-17.5 wt %.

### DETAILED DESCRIPTION

### Metal Alloy Composition

In an embodiment, a thermal spray material feedstock includes an iron-based alloy that is described by a compositional range. In embodiments, the iron-based alloy encompasses P147-X1 and meets the thermodynamic, microstructural, and performance criteria in the present disclosure. In example embodiments, the iron-based alloy is substantially free of chromium and nickel. The lack of chromium and nickel in the alloy is advantageous for minimizing health and safety concerns when welding or thermally spraying the material.

In embodiments, the iron-based alloy composition comprises in weight percent the following:
1.8-12.0 of Al;
1.8-7.5 of B;
0.0-2.0 of C;
0.0-4.5 of Mo;
0.0-6.5 of V; and
a balance of Fe.

In embodiments, the iron-based alloy composition comprises in weight percent the following:
5-12 of Al;
1.8-7.5 of B;
0-2 of C;
0-4.5 of Mo;
0-6.5 of V; and
a balance of Fe.

In embodiments, the iron-based alloy composition comprises in weight percent the following:
1.8-12.0 of Al;
1.8-7.5 of B;
0.5-2.0 of C;
1.0-4.5 of Mo;
1.0-6.5 of V; and
a balance of Fe.

In an embodiment, the iron-based alloy composition comprises in weight percent the following:
5.0-10.5 of Al;
3.0-6.5 of B;
0.0-1.2 of C;
0.0-2.5 of Mo;
0.0-5.5 of V; and
a balance of Fe.

In an embodiment, the iron-based alloy composition comprises in weight percent the following:
5.0-10.5 of Al;
3.0-6.5 of B;
0.5-1.2 of C;
1.0-2.5 of Mo;
1.0-5.5 of V; and
a balance of Fe.

The iron-based alloy composition of the present disclosure does not necessarily include C, Mo, and V. In some embodiments, the iron-based alloy composition includes C, Mo, and V. In other embodiments, the iron-based alloy composition does not include C, Mo, and V. In an embodiment, the iron-based alloy composition includes 2≥C≥0 in wt %; 4.5≥Mo≥0 in wt %; and 6.5≥V≥0 in wt %. In a preferred embodiment, the iron-based alloy composition includes 0.7-2.0 wt % of C, 1.1-4.5 wt % of Mo, and 1.3-6.5 wt % of V. In a more preferred embodiment, the iron-based alloy composition includes 0.7-1.2 wt % of C, 1.1-2.5 wt % of Mo, and 1.3-5.5 wt % of V.

Table I lists the nominal experimental alloy compositions, in weight percent with the balance of Fe, which are produced in the form of small-scale ingots to conduct this study.

TABLE I

| Alloy | Al | B | C | Mo | V |
|---|---|---|---|---|---|
| P147-X1 | 5.12 | 4.31 | | | |
| P147-X2 | 8.51 | 3.08 | | | |
| P147-X3 | 11.91 | 1.85 | | | |
| P147-X4 | 5.12 | 3.70 | | 2.35 | |
| P147-X5 | 5.12 | 3.70 | | | 2.68 |
| P147-X6 | 5.12 | 3.70 | | 1.18 | 1.34 |
| P147-X7 | | 4.31 | | | 8.00 |
| P147-X8 | | 4.31 | | 2.35 | 5.35 |
| P147-X9 | 5.12 | 4.31 | | 1.18 | 1.34 |
| P147-X10 | 10.22 | 4.31 | | | |
| P147-X11 | 6.82 | 4.93 | | | |
| P147-X12 | 5.12 | 5.24 | | | |
| P147-X13 | 10.22 | 6.37 | 0.78 | | |
| P147-X14 | 10.21 | 6.16 | 1.13 | 2.35 | 2.68 |

### Thermodynamic Criteria

Example embodiments of the present disclosure relate to alloys that are described by certain equilibrium thermodynamic criteria. The alloys can meet some, or all the described thermodynamic criteria.

The first thermodynamic criterion relates to the corrosion resistance of the alloy. This criterion is defined as the total aluminum content in weight % in the disordered body-centered cubic (BCC_A2) matrix phase at 1300K. Tracking the aluminum content in weight % in the BCC_A2 matrix allows for the production of an alloy with a maximum amount of aluminum in the matrix phase. The primary function of the aluminum is to enhance the corrosion resistance of the alloy. This criterion is important for aiding in the production of a corrosion resistant chromium-free alloy.

In an embodiment, the aluminum content in a BCC_A2 matrix phase at 1300K is 5 wt % or more. In another embodiment, the aluminum content in a BCC_A2 matrix phase at 1300K is 10 wt % or more. In yet another embodiment, the aluminum content in a BCC_A2 matrix phase at 1300K is 15 wt % or more. In an embodiment, the aluminum in BCC_A2 matrix phase at 1300K is 5.0-20.0 wt %. In another embodiment, the aluminum in BCC_A2 matrix phase at 1300K is 10.0-20.0 wt %. In yet another embodiment, the aluminum in BCC_A2 matrix phase at 1300K is 15.0-20.0 wt %. The presence of Al is necessary in the BCC_A2 phase to provide maximum corrosion resistance. A higher corrosion resistance is obtained when the Al content in BCC_A2 is within these ranges. However, a higher corrosion resistance is obtained when the range is 15.0-20.0 wt % as compared to a range of 5.0-20.0 wt %.

The second thermodynamic criterion relates to the wear-resistance and hardness of the alloy. This criterion is defined as the total mole fraction of boride phase present at 1300K. Example embodiments of the boride phase include iron boride, molybdenum boride, vanadium boride, and a combination thereof. The boride phases impart hardness and wear-resistance to the alloy.

In an embodiment of the present disclosure, the total boride mole fraction at 1300K is 15.0 mole % or greater. In another embodiment, the total boride mole fraction at 1300K is 35.0 mole % or greater. In yet another embodiment, the total boride mole fraction at 1300K is 50.0 mole % or greater.

Error! Reference source not found. lists the experimental alloys which meet the two thermodynamic criteria and their calculated thermodynamic results.

TABLE II

| Alloy | Al in BCC_A2 @ 1300K | Total Boride @ 1300K |
|---|---|---|
| P147-X1 | 10.0 | 54.1 |
| P147-X2 | 13.1 | 39.1 |
| P147-X3 | 15.1 | 23.7 |
| P147-X4 | 8.9 | 47.7 |
| P147-X5 | 7.8 | 42.4 |
| P147-X6 | 8.5 | 45.6 |
| P147-X7 | 0.0 | 48.0 |
| P147-X8 | 0.0 | 51.0 |
| P147-X9 | 9.6 | 52.3 |
| P147-X10 | 17.4 | 46.0 |
| P147-X11 | 15.5 | 59.8 |
| P147-X12 | 12.6 | 63.8 |
| P147-X13 | 19.0 | 46.7 |
| P147-X14 | 19.4 | 44.1 |

### Microstructure Criteria

In embodiments, the alloys are described by microstructural criteria. The alloys can meet some, or all, of the described microstructural criteria.

The first microstructure criterion relates to the measured aluminum content in the disordered BCC matrix phase of the alloy or coating microstructure. A minimum aluminum content is required to achieve the desired corrosion resistance. In embodiments, the aluminum content in the alloy microstructure is 3 wt % or more. In another embodiment, the aluminum content in the alloy microstructure is 5 wt % or more. In yet another embodiment, the aluminum content in the alloy microstructure is 10 wt % or more. In an embodiment, the aluminum content in the alloy microstructure is 3.0-25.0 wt %. In another embodiment, the aluminum content in the alloy microstructure is 5.0-25.0 wt %. In yet another embodiment, the aluminum content in the alloy's microstructure is 10-25 wt %.

The second microstructure criterion relates to the hardness of the alloy or coating. A minimum hardness is required to achieve an appropriate level of wear-resistance. In an embodiment, the average hardness of the alloy or coating is 800 HV_{0.3} or more. In a preferred embodiment, the average hardness of the alloy or coating is 900 HV_{0.3} or more. In an embodiment, the average hardness of the alloy or coating is −800-1300 HV_{0.3}. In another embodiment, the average hardness of the alloy or coating is −900-1200 HV_{0.3}. In yet another embodiment, the average hardness of the alloy or coating is −950-1100 HV_{0.3}.

Table II lists all the experimentally measured microstructure criteria for the experimental alloys produced in this study, which are produced in the form of lab-scale ingots to evaluate their respective properties as an alloy before manufacturing into a wire.

TABLE II

| | Measured Al in Microstructure | Alloy Hardness |
|---|---|---|
| Alloy | (wt %) | (HV_{0.3}) |
| P147-X1 | 9.7 | 808 |
| P147-X2 | 15.5 | 511 |
| P147-X3 | 17.1 | 518 |
| P147-X4 | 12.5 | 599 |
| P147-X5 | 11.8 | 673 |
| P147-X6 | 9.7 | 663 |
| P147-X7 | 0.0 | 596 |
| P147-X8 | 0.0 | 751 |
| P147-X9 | 10.0 | 717 |
| P147-X10 | 24.2 | 886 |
| P147-X11 | 10.6 | 863 |
| P147-X12 | 8.1 | 766 |
| P147-X13 | 21.7 | 944 |
| P147-X14 | 22.0 | 1064 |

After evaluation of the experimental alloys listed in Table III, the alloys of P147-X11, P147-X13, and P147-X14 were each manufactured into a wire, sprayed to form a coating, and measured to determine the hardness of the resulting coating.

Table IIIV lists the average coating hardness (HV_{0.3}), minimum coating hardness (Min (HV_{0.3})), and maximum coating hardness (Max (HV_{0.3})) of the three alloys which were determined by at least twelve independent hardness measurements. For comparison, a material covered under Patent Document 6, specifically Al 1.4, B 0.9, C: 2.5, Mo 8.3, Mn 0.2, Si 0.15, and V 9.6 was sprayed under similar conditions. As shown, this chemistry produced a less than desirable hardness via the arc spray process.

TABLE IV

| | Average Coating Hardness | Min | Max |
|---|---|---|---|
| Alloy | (HV_{0.3}) | (HV_{0.3}) | (HV_{0.3}) |
| P147-X11 | 970 | 808 | 1118 |
| P147-X13 | 1028 | 882 | 1167 |
| P147-X14 | 972 | 673 | 1250 |
| Patent | 546 | 451 | 700 |
| Document 6 | | | |
| Chemistry | | | |

The resultant coatings were produced by a twin wire arc process using the experimental parameters listed in Table V.

TABLE V

| Wire Name | P147-X11 | | P147-X13 | | P147-X14 | |
|---|---|---|---|---|---|---|
| Gun Type | PPG | | PPG | | PPG | |
| Controller | Smart Arc | | Smart Arc | | Smart Arc | |
| Air Cap | Fine | | Fine | | Fine | |
| Primary Gas Type | Air | | Air | | Air | |
| Primary Air Pressure | 60 | psi | 60 | psi | 60 | psi |
| Amperage | 200 | | 200 | | 200 | |
| Volts | 29 | | 29 | | 29 | |
| Spray Distance | 127 | mm | 127 | mm | 127 | mm |
| Part Diameter | 305 | mm | 305 | mm | 305 | mm |
| Surface Speed | 60 | m/min | 60 | m/min | 60 | m/min |
| Rotation Speed | 63 | rpm | 63 | rpm | 63 | rpm |
| Step | 8.0 | mm | 8.0 | mm | 8.0 | mm |
| Traverse | 8.0 | mm/sec | 8.0 | mm/sec | 8.0 | mm/sec |
| Number of Passes | 32 | | 32 | | 32 | |
| Coating Thickness | 780 | μm | 808 | μm | 876 | μm |
| Application Rate | 24.37 | μm/pass | 25.24 | μm/pass | 27.38 | μm/pass |

| | | | |
|---|---|---|---|
| Deposit Efficiency | 68.3% | 66.4% | 66.1% |

In embodiments, a hardfacing material is produced with a thermal spray material feedstock that includes the iron-based alloy. In embodiments, the hardfacing material is manufactured by plasma spraying, laser cladding, or welding the thermal spray material feedstock onto pulp and paper rolls to obtain the hardfacing material. In other embodiments, the hardfacing material is manufactured by plasma spraying, laser cladding, or welding the thermal spray material feedstock onto a wear-resistant material to obtain the hardfacing material.

In embodiments, the hardfacing material includes a hardface coating including 15.5-65.5 mol % of at least one boride phase in an Fe—Al BCC matrix phase. In embodiments, the at least one boride phase is a Fe₂B boride phase, a Mo₃B₂ boride phase, a V₃B₄ boride phase, and a combination thereof. In embodiments, the Fe—Al BCC matrix phase includes 5.5-17.5 wt % of Al.

Further, at least because the invention is disclosed herein in a manner that enables one to make and use it, by virtue of the disclosure of particular exemplary embodiments, such as for simplicity or efficiency, for example, the invention can be practiced in the absence of any additional element or additional structure that is not specifically disclosed herein.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A thermal spray material feedstock, comprising:
an iron-based alloy comprising:
5-12 wt % of Al;
1.8-7.5 wt % of B;
0-2 wt % of C;
0-4.5 wt % of Mo;
0-6.5 wt % of V; and
a balance of Fe,
wherein when the iron-based alloy is substantially free of chromium and nickel.

2. The thermal spray material feedstock of claim 1, wherein the iron-based alloy comprises:
5-10.5 wt % of Al;
3-6.5 wt % of B;
0-1.2 wt % of C;
0-2.5 wt % of Mo;
0-5.5 wt % of V; and
a balance of Fe.

3. The thermal spray material feedstock of claim 1, wherein the iron-based alloy further comprises:
0.7-2 wt % of C;
1.1-4.5 wt % of Mo; and
1.3-6.5 wt % of V.

4. The thermal spray material feedstock of claim 2, wherein the iron-based alloy further comprises:
0.7-1.2 wt % of C;
1.1-2.5 wt % of Mo; and
1.3-5.5 wt % of V.

5. A method for manufacturing a hardfacing material comprising:
plasma spraying, laser cladding, or welding the thermal spray material feedstock of claim 1 onto pulp and paper rolls to obtain the hardfacing material.

6. A method for manufacturing a hardfacing material comprising:
plasma spraying, laser cladding, or welding the thermal spray material feedstock of claim 1 onto a wear-resistant material to obtain the hardfacing material.

7. A hardfacing material comprising the iron-based alloy of claim 1.

8. The hardfacing material of claim 7, wherein the hardfacing material comprises a hardface coating comprising 15.5-65.5 mol % of at least one boride phase in an Fe—Al BCC matrix phase.

9. The hardfacing material of claim 8, wherein the at least one boride phase is at least one selected from the group consisting of a Fe₂B boride phase, a Mo₃B₂ boride phase, a V₃B₄ boride phase, and a combination thereof.

10. The hardfacing material of claim 9, wherein the Fe—Al BCC matrix phase comprises 15.5-65.5 mol % of the at least one boride phase.

11. The hardfacing material of claim 8, wherein the Fe—Al BCC matrix phase comprises 5.5-17.5 wt % of Al.

12. The thermal spray material feedstock of claim 1, wherein the iron-based alloy comprises a total weight % aluminum content that is above 5 wt % in a BCC_A2 matrix phase at 1300K.

13. The thermal spray material feedstock of claim 1, wherein the iron-based alloy comprises a total weight % aluminum content that is above 10 wt % in a BCC_A2 matrix phase at 1300K.

14. The thermal spray material feedstock of claim 1, wherein the iron-based alloy comprises a total weight % aluminum content that is above 15 wt % in a BCC_A2 matrix phase at 1300K.

15. The thermal spray material feedstock of claim 1, wherein a total mole fraction of a boride phase present at 1300K is 15 mol % or greater.

16. The thermal spray material feedstock of claim 1, wherein a total mole fraction of a boride phase present at 1300K is 35 mol % or greater.

17. The thermal spray material feedstock of claim 1, wherein a total mole fraction of a boride phase present at 1300K is 50 mol % or greater.

18. The thermal spray material feedstock of claim 1, wherein the iron-based alloy comprises 3 wt % or greater of Al in a microstructure of the iron-based alloy.

19. The thermal spray material feedstock of claim 1, wherein the iron-based alloy comprises 5 wt % or greater of Al in a microstructure of the iron-based alloy.

20. The thermal spray material feedstock of claim 1, wherein the iron-based alloy comprises 10 wt % or greater of Al in a microstructure of the iron-based alloy.

21. The thermal spray material feedstock of claim 1, wherein the iron-based alloy comprises a hardness of 800 HV_{0.3} or more.

22. The thermal spray material feedstock of claim 1, wherein the iron-based alloy comprises a hardness of 900 HV_{0.3} or more.

23. A Yankee dryer comprising the thermal spray material feedstock of claim 1.
